(19) United States
(12) Patent Application Publication
(10) Pub. No.: US 2004/0108939 A1
(43) Pub. Date: Jun. 10, 2004

(54) Wireless fencing system with tetherless leash

(76) Inventor: Salvatore John Giunta, Stroudsburg, PA (US)

Correspondence Address: DEMONT & BREYER, LLC, SUITE 250, 100 COMMONS WAY, HOLMDEL, NJ, 07733, US

(21) Appl. No.: 10/313,604

(22) Filed: Dec. 5, 2002

(51) Int. Cl. H04B 1/00

(52) U.S. Cl. 340/572.1

(57) ABSTRACT

A tetherless leash and fencing system comprising a wireless locator, a mapper that maps a perimeter based on a positional reading obtained by the wireless locator, a calculator that determines a vector of movement and position of the wireless locator relative to the perimeter, and a stimulator that generates a stimulus as a function of the vector of movement and the position of the wireless locator relative to the perimeter. If the perimeter is violated, the system determines a further perimeter and the calculator determines a vector of movement and position relative to the second perimeter and not the first perimeter. Also, no stimulation is applied when the first perimeter is crossed from the outside.

### FIELD OF THE INVENTION

The present invention relates to barriers and, more particularly, to fencing systems that do not use a material barrier.

### BACKGROUND OF THE INVENTION

For centuries, mankind has built walls and fences to exclude (e.g., invaders, etc.) or to contain (e.g., animals, etc.). In contemporary society, fences are often used to prevent pets and livestock from wandering.

Notwithstanding the wide variety of types and styles of fences that are available, fences are sometimes impractical, uneconomical, or objectionable on aesthetic grounds. In response to these and other objections, “virtual” fences have been developed that do not use a material barrier (e.g., planks, chain-links, etc.) for confinement. Rather, these fences establish a virtual barrier in the form of an “electronic” perimeter.

Some virtual fences establish the electronic perimeter using a buried wire(s) and a receiver. The wire acts as an antenna that broadcasts a low-level signal. A device, which is typically attached to the collar of an animal being monitored, includes a radio-frequency (“RF”) receiver and a means for generating and administering a stimulus. When the confined animal approaches the electronic perimeter, the device detects the signal broadcast by the wire and emits a stimulus. The stimulus, which is usually a sound, an electric shock, or both, is unpleasant to the confined animal. The animal learns to keep clear of the electronic perimeter in order to avoid the stimulus. Through this conditioning, a virtual barrier or fence is created.

Some virtual fences do not use buried wire. Some of these “wireless” systems include a stationary RF transmitter, and a portable receiver that is attached to a confined animal. When the portable receiver reaches the limit of the RF field that is generated by the stationary transmitter, the portable receiver administers a correction response to the animal.

While this type of wireless virtual fence is easier and more economical to install than a wired system, any interference between the transceiver and the receiver negates its effectiveness. These systems are, therefore, more useful in areas that are relatively flat and free of obstructions. Furthermore, in order not to torture the confined animal, the correction response is temporary (e.g., 10 to 30 seconds, etc.) and thereafter terminated.

A further shortcoming of both wired and radio-location wireless virtual fences is that they are subject to interference from other virtual fences used by neighbors, since most such fences operate on one of a limited number of radio frequencies.

A further type of wireless, virtual fence uses a device that incorporates a radio navigation system, such as the Global Positioning System. Using the radio navigation system, the coordinates of a perimeter are defined and the device is attached to an animal. When the confined animal approaches the perimeter, the device produces a negative stimulus that teaches the animal to respect the perimeter.

Many radio navigation systems require a separate monitoring station to perform the position calculations and determine when stimulus is required. These determinations are conveyed using RF signals. These systems are therefore subject to the same limitations and drawbacks as the other wireless systems discussed above. Furthermore, some of these systems require that the monitoring station itself have a satellite positioning system in order to provide more accuracy to the geo-location calculations.

Therefore, the need exists for an improved virtual fence.

### SUMMARY OF THE INVENTION

The present invention is a wireless, virtual fence that avoids some of the costs and disadvantages associated with tetherless leashes in the prior art. A virtual fence in accordance with the illustrative embodiment of the present invention comprises a “tetherless leash” that restricts the movement of the confined animal. In accordance with the illustrative embodiments, the tetherless leash is self-contained and includes:

a wireless locator;

a mapper for determining at least one perimeter;

a calculator for determining a vector of movement (speed and direction) and a location of the tetherless leash (and a confined animal) relative to the perimeter; and

a stimulator for generating a stimulus on the occurrence of a condition.

The wireless locator, mapper, calculator, and stimulator are advantageously self-contained and located within a single housing that is attached to and carried by the animal that is to be confined.

The wireless locator is capable of receiving radiated signals and determining its position (and, therefore, the position of the confined animal) from those signals in well-known fashion. The wireless locator can be used to receive signals that are transmitted from extraterrestrial transmitters (e.g., satellites, etc.) or terrestrial transmitters (e.g., Loran-C towers, etc.) or a combination of the two. With regard to terrestrial transmitters, the signals can be transmitted from public transmitters (e.g., the Coast Guard's Loran C system, etc.) or from private transmitters that might be provided as a part of the fencing system.

In conjunction with positional information from the wireless locator, the mapper is capable of determining at least one perimeter. The perimeter defines a region of containment or exclusion.

In conjunction with positional information from the wireless locator, the calculator continually determines both: (1) a vector of movement of the confined animal, and (2) the location of the animal relative to the perimeter. Based on the vector and relative position calculations, in accordance with some embodiments of the present invention, the calculator decides whether a stimulus should be administered to the animal based on both: (i) the location of the animal relative to the perimeter, and (ii) the vector of movement of the animal. When the calculator decides that a stimulus should be administered, the stimulator determines the severity and type of stimulus and then administers it to the animal.

In some embodiments of the present invention, a stimulus is administered when the animal comes within a predefined distance to the perimeter —a stimulus zone. Once within the zone, the severity of the stimulus is based on a measure of the likelihood that the perimeter will be breached. The likelihood of breach is a function of the vector of movement (i.e., speed and direction) of the animal and the distance of the animal to the perimeter.

In some other embodiments, there is no predefined “stimulus zone;” rather, the application of a stimulus is solely a function of the estimated likelihood of a perimeter breach. The likelihood of breach is again a function of the vector of movement of animal, and its distance to the perimeter.

In accordance with some embodiments of the present invention, when the calculator determines that the confined animal has breached the first perimeter, the calculator directs the mapper to create a second perimeter that is expanded (or contracted) relative to the first perimeter. The second perimeter is a second attempt to contain (or exclude) the confined animal. The calculator then decides, as previously described, whether or not to administer a second — and more persuasive—stimulus with respect to the second perimeter. If and when the second perimeter is breached, a third perimeter is created, and additional perimeters are created as necessary, each with an increasingly persuasive deterrent.

When the animal decides, for whatever reason, to return to its original confinement (i.e., within the first perimeter), no stimulus is applied when a confined animal re-crosses the first (or any other) perimeter on its way towards its original confinement. But, once on the desired side of the first (or any other) perimeter, the stimulator is again functional to deter perimeter breach.

The ability of some embodiments of the present invention to:

map a second perimeter on breach of a first perimeter; and

withhold stimulus when a confined animal re-crosses a perimeter; and

establish a stimulus zone of variable size by estimating a likelihood of perimeter breach is an advance over the prior art, wherein:

there is no further restraint once a perimeter is breached;

there is a disincentive to re-cross a perimeter since doing so causes the stimulus; and

the stimulus zone has a fixed size, and does not account for the behavior of the confined animal.

### BRIEF DESCRIPTION OF THE DRAWINGS

FIG. 1 depicts a collar, and a tetherless leash in accordance with the illustrative embodiment of the present invention.

FIG. 2 depicts a block diagram of the salient components of the tetherless leash in accordance with the illustrative embodiment of the present invention.

FIG. 3 depicts an illustrative embodiment of the stimulator in FIG. 2.

FIG. 4 depicts the relationship between the likelihood of approach to or breach of a perimeter and the severity of stimulus, in accordance with the illustrative embodiment of the present invention.

FIG. 5 depicts a collar suitable for providing a vectored stimulus in accordance with the illustrative embodiment of the present invention.

FIG. 6 depicts a method in accordance with the illustrative embodiment of the present invention.

FIG. 7 depicts a battery system for use in conjunction with a tetherless leash in accordance with the illustrative embodiment.

FIG. 8 is a block diagram that depicts a variation of the illustrative embodiment wherein the tetherless leash is capable of receiving a correction to positional measurements.

FIG. 9 depicts a first electronic perimeter, wherein the perimeter is established and monitored by a tetherless leash in accordance with the illustrative embodiment of the present invention.

FIG. 10 depicts a confined animal within the first perimeter shown in FIG. 9.

FIG. 11 depicts the confined animal of FIG. 10 breaching the first perimeter of FIG. 9 and the establishment of a second and then third perimeter.

FIG. 12 depicts the confined animal of FIG. 11 re-crossing the second perimeter shown in FIG. 11.

FIG. 13 depicts the confined animal of FIG. 12 reentering the first perimeter of FIG. 9.

FIG. 14 depicts a geographic region having a first outer electronic perimeter and a second inner electronic perimeter, wherein the outer perimeter is for containment and the inner perimeter is for exclusion. FIG. 14 further depicts the use of a local differential unit for improving the accuracy of positional measurements.

FIG. 15 depicts an electronic perimeter having an arbitrary shape, and also depicts the use of a fixed positional reference.

FIG. 16 depicts a first electronic perimeter for exclusion, and a second electronic perimeter that is mapped after the first perimeter is breached.

### DETAILED DESCRIPTION

The illustrative embodiment of the present invention is a virtual fence that can be conceptualized as a tetherless leash. The tetherless leash is advantageously a self-contained unit (i.e., contained within a single housing), which is attached in some manner to an animal (“the confined animal”). For the purposes of this specification, the term “animal” is defined to include people as well as non-human animals.

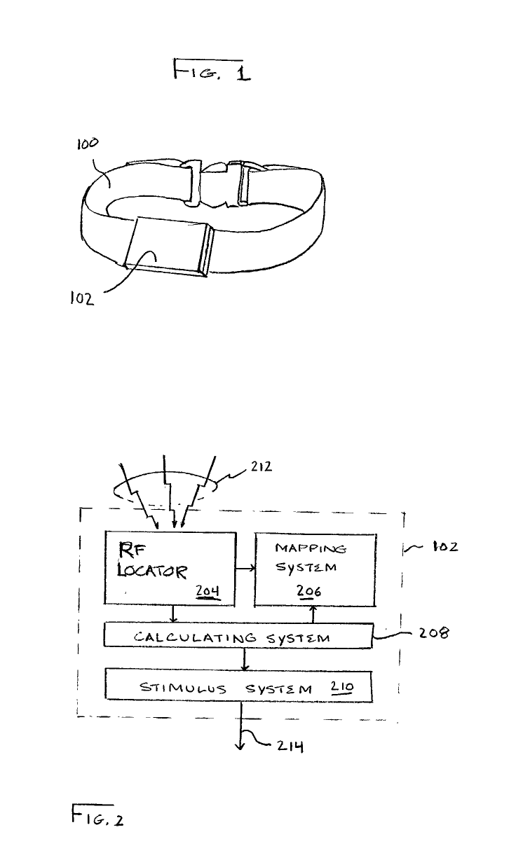

A common use for the illustrative tetherless leash is to contain a dog within a region (e.g., the pet owner's backyard, etc.). In such an application, tetherless leash 102 is advantageously attached to the dog's collar 100, as illustrated in FIG. 1. But other uses are contemplated for tetherless leash 102. For example, the tetherless leash can be used to limit the ranging of livestock or restrict the mobility of a human. If tetherless leash 102 is to be used in conjunction with a human, it can be attached, for example, to a wrist or ankle strap. Other ways for attaching a system, such as fencing system 102, to a confined animal, can suitably be used.

In addition to containing a confined animal within a region, tetherless leash 102 can be used to exclude an animal from a region (e.g., a garden, etc.). Hereinafter, as used in this specification, the term “contain” and its inflected forms is defined to refer to applications for containment or exclusion or containment and exclusion.

FIG. 2 depicts a block diagram of the salient components of tetherless leash 102 in accordance with the illustrative embodiment of the present invention. Tetherless leash 102 includes wireless locator 204, mapper 206, calculator 208 and stimulator 210, interrelated as shown. FIG. 6 depicts method 600 for establishing a virtual fence, in accordance with the illustrative embodiment of the invention.

Wireless locator 204 comprises a receiver that receives electromagnetic signals 212 and a means for calculating its position based on those signals. The results of the calculation are geo-coordinates, such as longitude and latitude. It will be clear to those skilled in the art how to make and use wireless locator 204.

In some embodiments of the present invention, wireless locator 204 is used in conjunction with an orbital (satellite-based) position-determining system, such as the Global Positioning System or “GPS.” In such embodiments, wireless locator 204 comprises a GPS receiver. Current GPS systems are accurate to within about 10 meters. This level of accuracy might be acceptable for general applications, such as cattle or wildlife containment, but might not be accurate enough for pet or human containment on small, urban and suburban lots. Alternative embodiments of tetherless leash 102 that provide improved positional accuracy are described later in this specification.

In some other embodiments, wireless locator 204 is used in conjunction with a public, terrestrial radio navigation system, such as Loran-C. In such embodiments, wireless locator 204 comprises a Loran receiver, in well-known fashion.

In some embodiments of the present invention, wireless locator 204 is used with private, terrestrial transmitters. A private system will include at least three transmitters, which will typically be used locally (i.e., in the vicinity of the monitored region) in conjunction with tetherless leash 102. The transmitters are advantageously coded, and both solar powered and battery powered.

In contrast to embodiments of tetherless leash 102 that use a satellite-based radio-navigation system or a public, terrestrial-based radio-navigation system, some embodiments that use a private, terrestrial-based position-determining system are not self-contained (i.e., at least local transmitters are required). Although not self-contained, these embodiments of tetherless leash 102 otherwise offer the same features and benefits as self-contained versions of tetherless leash 102.

The design and operation of satellite-based and terrestrial radio-navigations systems are well known to those skilled in the art and will not be described further.

Mapper 206 receives a reference set of geo-coordinate inputs from wireless locator 204 and generates from those geo-coordinates a perimeter according to its programming. The tasks of obtaining at least one set of geo-coordinates and generating a first perimeter according to programming compose operation 602 of method 600 (i.e., mapping the perimeter), which is disclosed in detail later in this specification.

After the first perimeter is set, calculating unit 208 receives periodic or sporadic input from wireless locator 204 and calculates a vector of movement of the confined animal. Since, after programming, wireless locator 204 (and other elements of tetherless leash 102) will be attached to a confined animal, this specification will simply refer to the vector of movement and position of “the confined animal,” rather than of wireless locator 204.

The term “vector of movement,” as used in this specification, is defined as a current direction of motion and a current speed. Calculating unit 208 then determines the distance of the confined animal to the perimeter. These tasks compose operation 604 of method 600 (i.e., calculate vector of motion and position), which is also described in detail below.

Based on the vector and positional estimates, calculating unit 208 also advantageously determines one or more of the following:

whether the confined animal has breached the perimeter, or, if not:

whether the confined animal is within a predefined stimulus zone (e.g., within 6 feet of the perimeter, etc.); and/or

an estimate of the likelihood of whether the confined animal will violate the perimeter.

These tasks compose operation 606 of method 600 (i.e., determine the position of the confined animal relative to the perimeter, and determine the likelihood of perimeter breach, if it hasn't occurred).

On occurrence of a condition, stimulator 210 is alerted. In some embodiments of the present invention, the condition is that the confined animal is determined to be within the stimulus zone; in some other embodiments, the condition is that a threshold likeliness of perimeter breach has been exceeded.

In response to the alert, stimulator 210 generates signal 214, which ultimately results in a stimulus that is sensed by the confined animal. In some embodiments of the present invention, the stimulus can be varied in severity or type or both, and is a function of the likelihood of breach, as described further below. The tasks of determining whether stimulator 210 is to be alerted, and the response of stimulator 210, are several of the tasks that compose operation 608 of method 600 (i.e., take appropriate action).

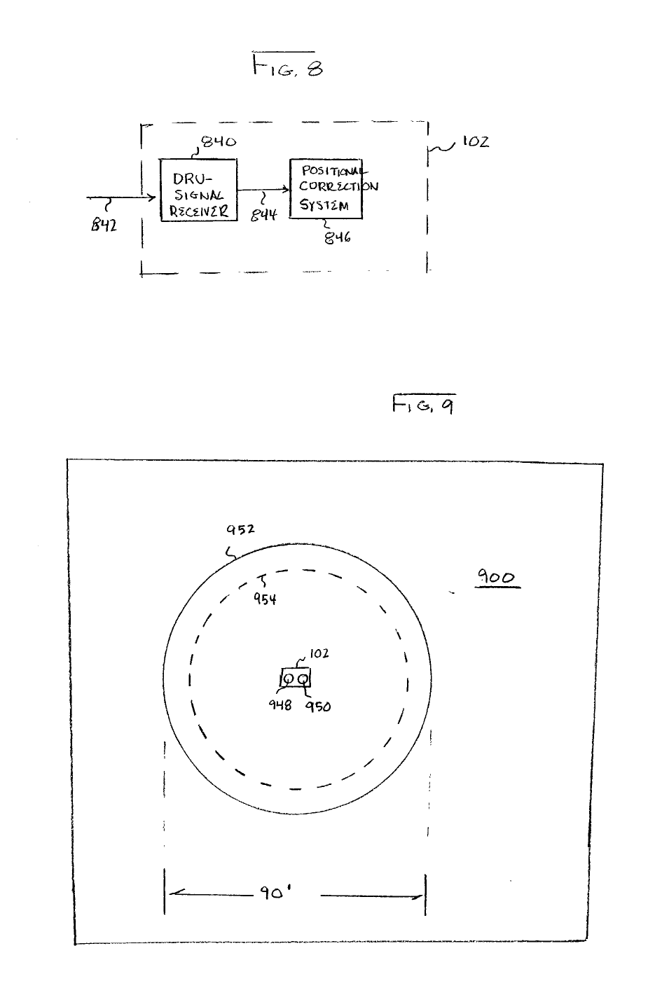

The various systems (e.g., mapper 206, calculator 208, etc.) shown in the Figures and described herein are depicted as individual but cooperating systems. This was done for pedagogical purposes (e.g., to emphasize their functionality, etc.). Those skilled in the art will recognize that the tasks performed by at least some of these “systems” can be performed by a single, suitably-programmed processor or other device. It is to be understood, therefore, that the depiction of any system or component of tetherless leash 102 as “discrete” or “individual” is representational only. Furthermore, those skilled in the art will appreciate that the functioning of and interaction between the various systems that compose tetherless leash 102 are coordinated by a controller (not depicted in FIG. 2, see, e.g., FIG. 7).

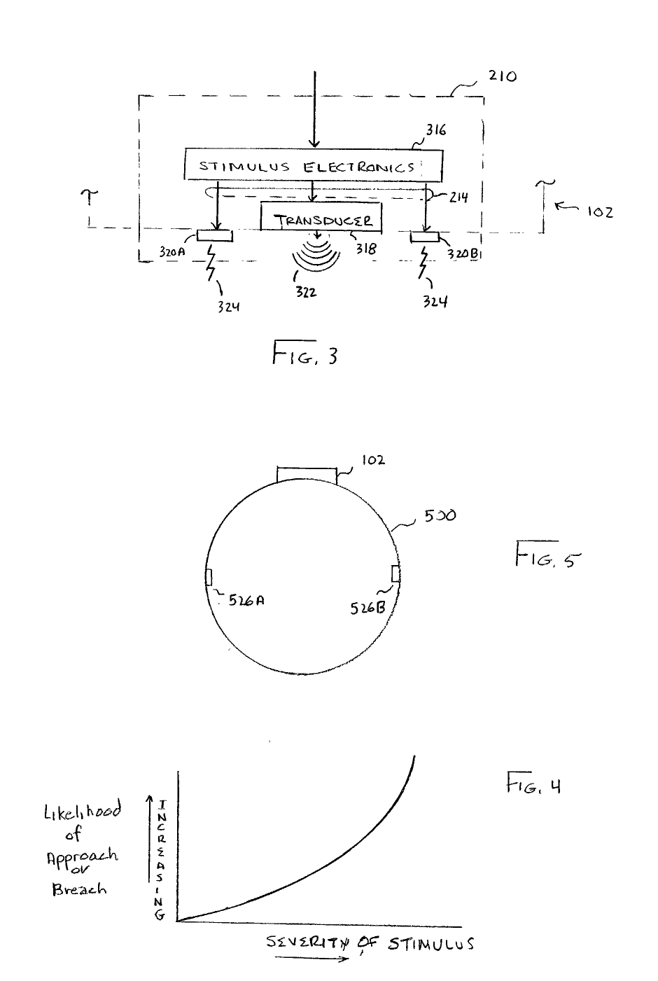

FIG. 3 depicts further detail of stimulator 210. In the embodiment depicted in FIG. 3, stimulator 210 includes stimulus electronics 316, transducer 318, and electrodes 320A and 320B. When stimulus electronics 316 receives a signal from calculating unit 208, it advantageously determines:

the type of stimulus to be applied; or

the severity of the applied stimulus; or

both the type of stimulus to be applied and the severity of the applied stimulus.

It will be appreciated that stimulus electronics 316 can suitably be implemented as software running on a processor (e.g., along with mapper 206 and calculator 208, etc.).

In some embodiments of the present invention, the stimulus provided by stimulator 210 is an auditory alert, such as a “beep,” but nothing more. In some alternative embodiments, the frequency of the auditory alert can be altered to a most appropriate frequency for a particular animal. For example, an ultrasonic signal is expected to be appropriate for most dogs, but some dogs, as well as some other animals, might respond better to a lower-frequency signal.

Stimulus electronics 316 is advantageously capable of varying the severity of the auditory alert as a function of the likelihood of perimeter breach. The phrase “varying the severity,” when used to describe an auditory alert, means a variation in pitch, duty cycle, repetition rate or volume, or combinations thereof. Typically, the severity of the alert should increase to a maximum as the likelihood of crossing the perimeter becomes imminent. This is illustrated graphically in FIG. 4. The rate of increase in severity as a function of the likelihood of perimeter breach can be linear, exponential, or any other type of suitable relation.

The variable auditory alert can be implemented in any of a variety of ways. By way of illustration, in some embodiments of the present invention, after receiving an estimate of the likelihood of perimeter breach from calculator 208, stimulus electronics 316 accesses a look-up table that provides stimulus severity as a function of this likelihood. After determining the appropriate stimulus severity from the table, a signal indicative thereof is sent to transducer 318. Based on that signal, transducer 318 generates audible alert 322 having the appropriate intensity.

In some embodiments of the present invention, stimulator 210 has the capability of providing an electric shock as an alternative, or in addition to, an audible alert. In some variations, at a relatively lower likelihood of perimeter breach, the stimulus is strictly auditory. As the likelihood of perimeter breach increases, the stimulus is an electric shock (or both shock and sound). The electric shock can be varied in severity. The phrase “varying the severity,” when used to describe an electric shock, means a variation in intensity, repetition rate or duration. In such embodiments, a signal is sent from stimulus electronics 316 to transducer 318 to generate audible alert 322, or to electrodes 320A and 320B to generate electric shock 324, or both.

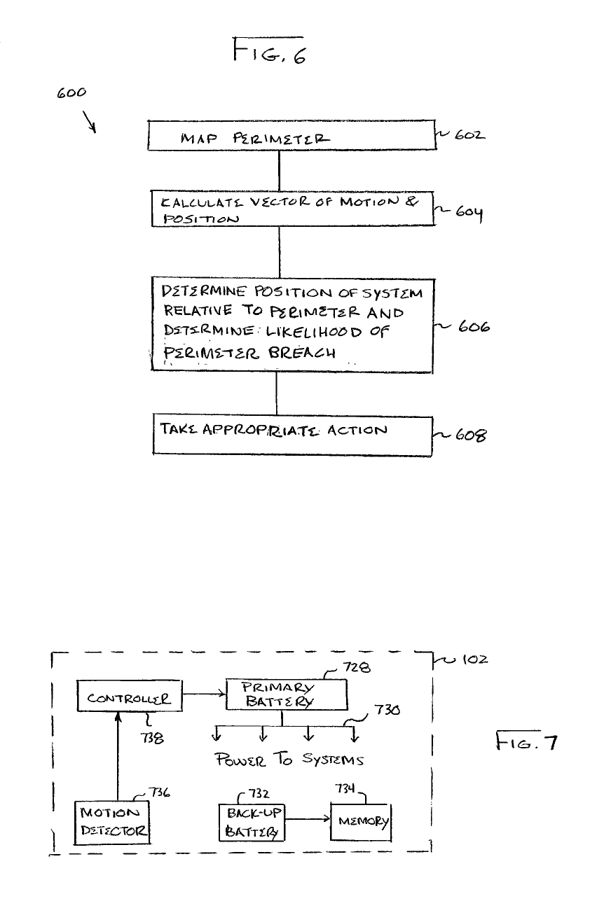

In some further embodiments, tetherless leash 102 is capable of providing a “vectored” or directional shock to a confined animal. This can be accomplished, for example, using a special collar 500, as depicted in FIG. 5. Collar 500 has shock terminals 526A and 526B that are appropriately positioned to engage the right and left side of the confined animal's neck. A shock applied to one side or the other is expected, in some cases, to be effective at changing an animal's direction of travel.

The description provided above addresses the response of tetherless leash 102 as a confined animal approaches a monitored perimeter. The following description addresses the response of tetherless leash 102 after a confined animal breaches a perimeter.

In some embodiments of the present invention, if a confined animal crosses the perimeter, tetherless leash 102 will stop shocking it and automatically expand (or contract, as appropriate for exclusion) the perimeter, thereby establishing a second perimeter. The system will then obtain positional readings and perform calculations in the manner previously described to determine when and if stimulus is applied. In any case, the severity of the stimulus will again increase to a maximum as the likelihood of breach of the second perimeter is imminent. Perimeter expansion can reoccur several times in an attempt to slow down and finally stop the confined animal.

If, after perimeter expansion, a change in the vector of movement of the confined animal is observed that indicates a decreased likelihood of perimeter breach, any applied stimulus is withdrawn or reduced in severity. Furthermore, to the extent that a confined animal approaches and then re-crosses any perimeter to reenter the desired region, no stimulus is applied. These responses to perimeter breach, in addition to the responses to a likelihood of perimeter breach as previously described, compose operation 608 of method 600 (i.e., take appropriate action).

These post-breach operations can be accomplished as follows. If calculator 208 determines that a confined animal is beyond the first perimeter, it notifies mapper 206. The mapper calculates a second perimeter so as to include (as appropriate) the confined animal within the second perimeter, advantageously taking into account the current vector of movement of the confined animal. Calculator 208 estimates the likelihood or probability, based on the vector of movement and position, of breach of the second perimeter. As appropriate, calculator 208 notifies stimulator 210 in the manner previously described. If the confined animal breaches the second perimeter, then mapper 206 calculates a third perimeter. The perimeter can expand (or contract, as appropriate for exclusion) several times in this fashion.

If calculator 208 determines that the confined animal is moving away from the expanded perimeter in the desired direction, it notifies stimulator 210 to stop or reduce the stimulus. No stimulus is generated as the confined animal crosses any perimeter in the desired direction.

The foregoing description presents the structure and operation of tetherless leash 102. The following description provides additional structural and operational details and several examples that illustrate perimeter expansion, perimeter contraction, and other features of tetherless leash 102.

### Battery Power

Tetherless leash 102 is advantageously battery powered. Battery size is primarily a function of desired operating cycle and the desired maximum severity of the stimulus. For example, for an equal operating life, a battery in a unit intended for a small dog is likely to be smaller than the battery in a unit intended for a cow, as the latter is expected to require a greater maximum severity of stimulus.

With reference to FIG. 7, primary battery 728 can be replaceable, rechargeable or both. Power is distributed via bus 730 to the various systems (not shown in FIG. 7, see, e.g., FIG. 2) within tetherless leash 102. Back-up battery 732 is advantageously used to maintain programming and results (e.g., how to generate a perimeter based on a set of coordinates, the geo-coordinates of the perimeter that has been mapped, etc.) in memory 734 while primary battery 728 is being charged, replaced or both.

In order to extend the life of primary battery 728, any of several methods known in the art can be employed to shut down operation of tetherless leash 102. For example, in some embodiments of the present invention, tetherless leash 102 includes motion detector 736, which detects whether the confined animal is moving. If it is not moving (e.g., the confined animal is sleeping), the system can safely shut down via controller 738. When motion is detected, then the system is restarted. Further, if the vector calculated by calculator 208 does not change for a period of time, or is changing very slowly, wireless locator 204 can take fewer positional calculations and thus save power.

### Mapping The Perimeter

To ready tetherless leash 102 for use, a perimeter that delimits the desired containment area must be defined. The perimeter is defined by obtaining one or more sets of positional coordinates (e.g., latitude and longitude, etc.). In conjunction with programming (e.g., a pre-defined shape of the perimeter), the positional coordinates are used to map the monitored perimeter.

In some embodiments of the present invention, a single set of coordinates is obtained, which coordinates are used to generate other coordinates. For example, a single set of coordinates can be used to define a circular perimeter having a predetermined radius or diameter. One way to do this is to position tetherless leash 102 at the center of a region to be monitored. A set of satellite-based coordinates corresponding to that position is then obtained. This can be accomplished, for example, by pushing a first button that causes wireless locator 204 to obtain a positional fix. The coordinates obtained by wireless locator 204 are advantageously stored in memory as the polar coordinate origin of the monitored region.

The perimeter can then be established applying a minimum increment in radius or diameter, (e.g., 7.5 feet, etc.), which is already advantageously stored in memory. With each push of a second button, mapper 206 maps a perimeter of a circular region having, as its center, the polar coordinate origin, and a radius or diameter that is a multiple of the predefined minimum size increment. In other words, the first push of the second button defines a perimeter for a monitored region of circular shape and having a center at the stored polar coordinate origin and a radius of 7.5 feet. A second push of the second button defines a perimeter for a circular region having the polar coordinate origin and a radius of 15 feet, and so forth.

Rather than using a second button to set the range as described above, a single, multi-function button could be used for this purpose in known fashion. For example, after obtaining the coordinates of the center of the circular perimeter, tetherless leash 102 could generate a sound (e.g., two “beeps,” etc.) to acknowledge that the center coordinate was set. Then, subsequent entries would establish range.

In some other embodiments, mapper 206 is preprogrammed to generate a polygon-shaped perimeter from a single set of satellite-based coordinates. One way to do this is for a user to stand at a defined spot on the polygon (e.g., a vertex, etc.) facing a predetermined direction. At the press of a button, satellite-based coordinates of that location are obtained. Based on those coordinates, and a definition of the polygon that is stored in memory, mapper 206 maps a perimeter. Alternatively, the user can go to two or more predefined locations on the perimeter of the polygon and obtain coordinates for those locations. Mapper 206 then maps the perimeter using the two or more coordinates. In a further variation, the user can define the entire perimeter by walking around it and obtaining a set of coordinates at each vertex.

In yet some further embodiments, a perimeter having an arbitrary shape can be defined. This can be done by simply walking the perimeter and obtaining coordinates at each vertex. Alternatively, the perimeter can be drawn on a survey map which is forwarded to the manufacturer for preprogramming. Alternatively, with appropriate software and a personal computer, etc., the user can map an arbitrarily-shaped perimeter.

In some additional embodiments, an outer perimeter can be defined that delimits the boundaries of a region of containment, and one or more inner perimeters that are disposed within the outer perimeter can be defined that delimit the boundaries of a region of exclusion. An example of such an embodiment is presented later in this specification.

### Portability

Since virtual fencing unit 102 is self contained in at least some embodiments, it is portable. In some embodiments of the present invention, virtual fencing unit 102 maintains a “home” perimeter in memory, and is capable of creating a new one when a user (e.g., pet owner, etc.) is at a different location (e.g., at a park, camp site, vacation home, etc.) and has a need to create a temporary confinement zone.

### Improving Positional Accuracy

As previously indicated, current satellite-based position-determining systems are accurate to within about 10 meters. This level of accuracy might not be acceptable for some applications, such as pet or human containment on small, urban and suburban lots.

In some embodiments of the present invention, positional accuracy can be improved to a resolution of about 2 meters using WMS or NDGPS differential beacons. These beacons provide an estimate of the fluctuating short-term positional error in GPS measurements and can be applied as a correction to the coordinates obtained by satellite positioning system 204.

For even greater accuracy, or in cases in which the signal from the beacons are blocked, a stationary differential reference unit (“DRU”) can be used. The stationary DRU, which is advantageously placed near to the monitored perimeter, initializes itself and then sends, on a continuous basis, correction information to tetherless leash 102. The stationary DRU can improve positional accuracy of tetherless leash 102 to the centimeter range.

When using beacons or local stationary DRUs, a second receiver 840 (i.e., in addition to the receiver contained in wireless locator 204) receives signal 842 indicative of the positional correction from differential beacons or the stationary DRU. Receiver 840 sends signal 844 to positional-correction system 846, which applies the correction to coordinates received by wireless locator 204.

In some further embodiments, improved stability, if not increased resolution, is obtained by correcting the long-term drift in satellite-based positional data. For example, in one implementation, a special water bowl (for a dog) that serves as a fixed positional reference is provided. The water bowl includes an emitter, such as an array of infrared LEDs. A dog collar having an appropriate sensor is also provided. As the dog that is wearing the collar leans over to drink from the bowl, the collar receives a signal from the bowl. If the dog bowl is kept at the same location, the signal provides a fixed positional reference that corrects for long-term drift in satellite positional measurements.

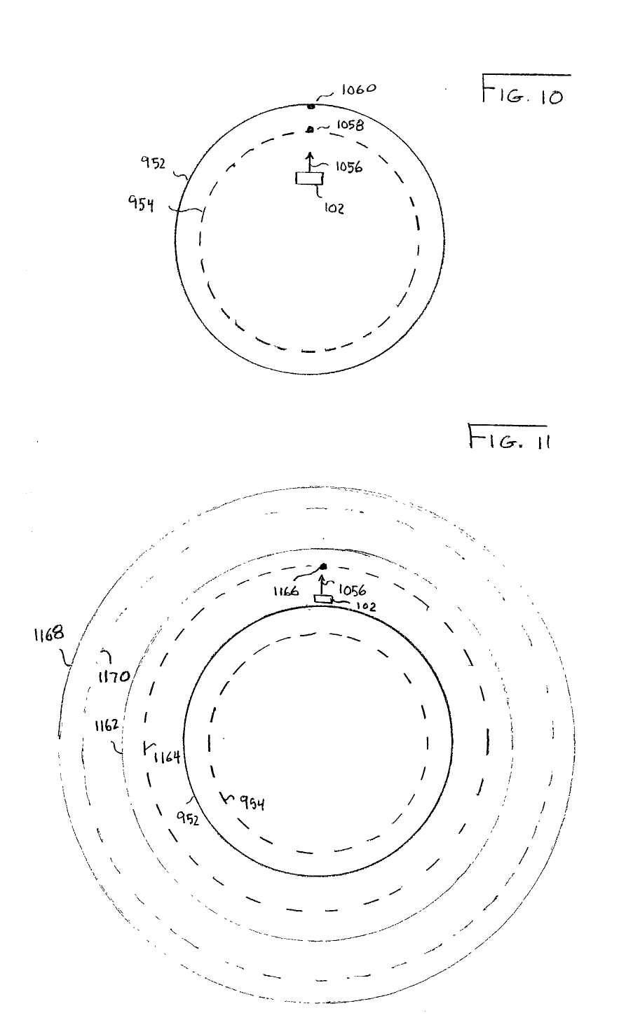

### EXAMPLE I (FIGS. 9 through 13)

FIG. 9 depicts a geographic region 900. As is true for each location on the surface of the Earth, each position within geographic region 900 can be identified by a latitudinal and longitudinal coordinate. By way of example, tetherless leash 102 (not to scale) is in geographic region 900, at a latitude of 41° 52′ 00″ N and a longitude of 88° 04′ 00″ W. According to this illustrative example, the user of tetherless leash 102 wants to set a circular perimeter that is approximately 90 feet in diameter. Tetherless leash 102 has been factory-programmed to determine its location, and then calculate a circular perimeter having some base increment of diameter.

The user presses button 948 on tetherless leash 102 to determine its current latitude and longitude as a center reference point. Tetherless leash 102 then calculates the coordinates of perimeter 952, with its center position as a reference point. The user can then adjust the radius (diameter) of perimeter 952 up or down in units of, for example, 7.5 feet using button 950, for example, until the desired diameter of perimeter 952 is established.

In this example, tetherless leash 102 calculates a fixed stimulus zone, which is the region between stimulus perimeter 954 (illustrated as a broken line) and perimeter 952. Once tetherless leash 102 is within the stimulus zone, a stimulus is generated. In order to test tetherless leash 102 after generating perimeter 952, the user moves tetherless leash 102 near perimeter 954 to determine whether the proper stimulus is generated.

Tetherless leash 102 is attached to an animal that is to be monitored. The animal might be a person under house arrest, for example, wherein the stimulus might be an audio signal reminding the monitored individual to remain inside perimeter 952. Alternatively, the confined animal might be a pet or livestock. In this case, it is known in the art that a shock stimulus is advantageously used alone or, preferably, in conjunction with an audio signal.

Referring now to FIG. 10, after initialization, a vector of movement of the confined animal) is calculated. In this example, the confined animal is moving at 3 miles per hour toward perimeter 952 on vector 1056. If and when the confined animal reaches stimulus perimeter 954, a stimulus is applied to the confined animal. In this example, the severity of the stimulus is a function of the relative likelihood of perimeter breach. In particular, a mild stimulus is applied when the confined animal reaches point 1058. The stimulus increases in intensity to a maximum at point 1060, which is on perimeter 952, in order to prompt the confined animal to move back from the perimeter.

Although in this example, a fixed stimulus zone was used, the stimulus zone can be variable, as previously indicated. For example, if a dog is lying still in the shade of a tree at point 1058, then perhaps no stimulus is required, since the dog shows little likelihood of breaching perimeter 952. If, however, at point 1058, the dog is moving toward perimeter 1052 at a slow walk, then a mild stimulus (e.g., a low-level audible alert, etc.), might be appropriate. And if, at point 1058, the dog is moving toward perimeter 1052 at top speed, the likelihood of perimeter breach is very high, and a severe stimulus is appropriate.

In fact, in the case of a high-speed approach, it would have been advantageous for the stimulus to be applied well before reaching point 1058. In this manner, basing stimulus decisions on a likelihood of breach, as a function of vector of movement and position, without regard to the confined animal's presence within a stimulus zone, is often a more effective approach to containment.

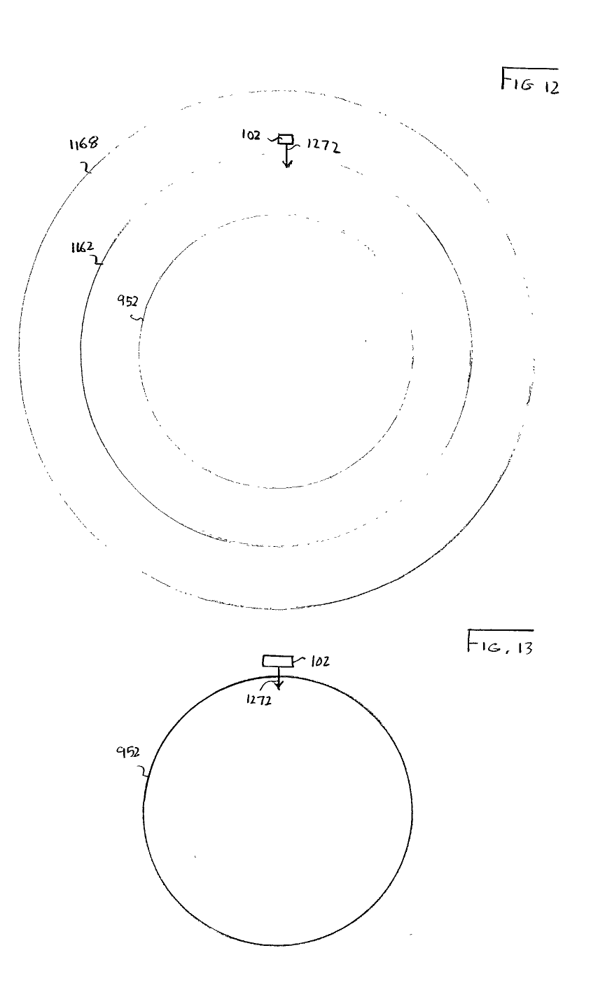

Referring now to FIG. 11, the confined animal has breached perimeter 952. In response to the perimeter breach, tetherless leash 102 calculates a second perimeter 1162. The stimulus zone is now the region between second stimulus perimeter 1164 and second perimeter 1162. As the confined animal crosses stimulus perimeter 1164 at point 1166 along vector 1056, a stimulus proportionate with the vector is applied, as before. If second perimeter 1162 is crossed, a third perimeter 1168 and third stimulus zone 1170 are defined. The third stimulus perimeter 1168 is mapped and a stimulus is applied as appropriate.

FIG. 12 depicts the confined animal moving back over the second perimeter along vector 1272. Second stimulus perimeter 1164 is not depicted in FIG. 12 to indicate that as the confined animal moves back across second perimeter 1162, no stimulus is applied.

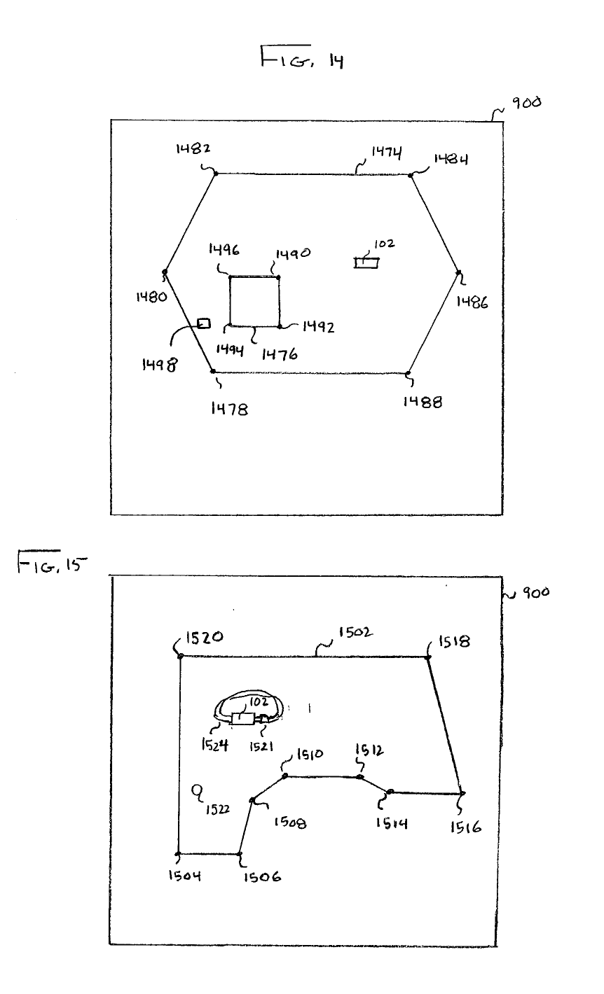

In FIG. 13, third perimeter 1166 and second perimeter 1162 have been “discarded” (i.e., not active) as the confined animal crosses back into first perimeter 952 along vector 1272. First stimulus perimeter 954 is not depicted in FIG. 13 to indicate that as the confined animal moves back across first perimeter 952, no stimulus is applied. If a change in the vector of movement of the confined animal is observed (e.g., the dog turning back to cross first perimeter 952 again), then first stimulus perimeter 954 would be reestablished and a stimulus would be applied.

The sequence of events described in EXAMPLE I show how a confined animal is encouraged to slow down, stop and move back into an original perimeter.

### EXAMPLE II (FIG. 14)

FIG. 14 depicts geographic region 900. In this example, tetherless leash 102 is used to map and monitor outer perimeter 1474 having a polygonal-shape. The perimeter is advantageously mapped as follows. First, flags or some other type of physical markers are manually placed at each vertex of the desired perimeter. Then, geo-coordinates are obtained at each flagged location. For some systems, it is not important that the perimeter is walked in straight lines; however, the positional order of the flags (vertices) should be followed. For example, starting at point 1478, a first reading is obtained. Readings are obtained successively at points 1480, 1482, 1484, 1486, 1488 to fully define perimeter 1474.

In some embodiments of the present invention, a second reading is taken at point 1478 to “close” the perimeter. This indicates to tetherless leash 102 that all coordinates for a first perimeter have been provided.

After the first perimeter is closed and defined, one or more interior regions (e.g., a vegetable garden, a pool, etc.) can be defined or “carved out” from which the animal is to be excluded. These carve-outs can be defined by defining perimeters after the primary perimeter (e.g., perimeter 1474, etc.) is defined. When the mapper calculates that the second and subsequent perimeter defines an area within the first perimeter, the mapper can reasonably assume that the second and subsequent perimeters define carve-outs of the first region. Subsequent coordinates, therefore, are understood by tetherless leash 102 to define a second or subsequent carve-out.

It is noteworthy that in this Example, outer perimeter 1474 defines a region in which a confined animal is to be contained, wherein inner perimeter 1476 defines a region from which a confined animal is to be excluded. In this Example, stimulus is applied strictly as a function of the relative likelihood of perimeter breach; that is, there is no pre-defined stimulus zone. As previously described, if calculator 208 determines that there is a threshold likeliness of perimeter breach, a stimulus is applied. If outer perimeter 1474 is breached, mapper 206 maps an expanded perimeter (not depicted). If inner perimeter 1476 is breached, mapper 206 maps a contracted perimeter.

For this Example, stationary DRU 1498 sends positional corrections to a second receiver in tetherless leash 102 to increase the resolution of the system.

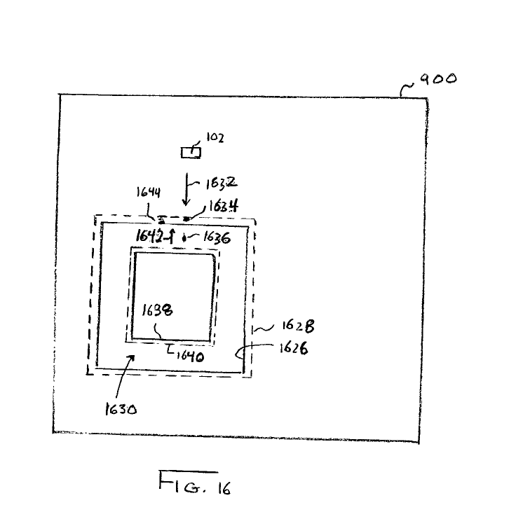

### EXAMPLE III (FIG. 15)

FIG. 15 depicts geographic region 900. In this example, tetherless leash 102 is used to map and monitor perimeter 1502 having an arbitrary shape. Geo-coordinates are obtained for each of the vertices (i.e., 1504 through 1520) via wireless locator 204. The geo-coordinates that are obtained from wireless locator 204 are used by mapper 206 to map perimeter 1502.

Fixed reference 1522, which in this example is a specially-modified dog bowl, is used to provide a fixed positional reference to correct for long-term drift in the satellite positional readings. In this example, the dog bowl (i.e., fixed reference 1522) emits a signal that is sensed by sensor 1521 in collar 1524 worn by a confined animal (not depicted).

### EXAMPLE IV (FIG. 16)

FIG. 16 depicts geographic region 900. In this Example, tetherless leash 102 is used to map and monitor perimeter 1626 to exclude a confined animal (not depicted) from region 1630.

In use, the perimeter is mapped in any of the ways previously described. Tetherless leash 102 is attached to an animal to be monitored. The geo-coordinates of the confined animal are obtained. In this case, calculator 208 determines that confined animal has a vector of movement 1632 and position 1634, which is within stimulus perimeter 1628. The vector of movement indicates a speed of 4 miles per hour heading directly toward perimeter 1626. Calculator 208 determines that there is a substantial likelihood that the confined animal will cross perimeter 1626. Stimulator 210 determines that an auditory alert at maximum severity and an electric shock at 60 percent of maximum severity should be applied, and does so.

Based on subsequent positional readings, calculator 208 determines that perimeter 1626 has been breached, wherein the confined animal is located at position 1636. Stimulus is withdrawn and second perimeter 1638 is mapped. The geo-coordinates of the confined animal are obtained. Calculator 208 determines that the confined animal has not reached second stimulus perimeter 1640. It is further determined that the confined animal is moving back toward first perimeter 1626. Consequently, stimulus is not applied. Based on a subsequent reading, the confined animal is determined to be just beyond, and on the desired side of perimeter 1626. Since the confined animal has re-crossed perimeter 1626, and since vector of movement 1642 indicates that the confined animal is moving away from that perimeter, no stimulus is applied (even though the confined animal is within stimulus perimeter 1628).

It is to be understood that the above-described embodiments are merely illustrative of the invention and that many variations can be devised by those skilled in the art without departing from the scope of the invention. For example, although the illustrative embodiments refer to the use of a wireless locator, wherein RF is typically defined as electromagnetic energy having a wavelength between audio and the light range, the use of signals outside of this range for geo location is within the contemplated scope of the present invention. It is therefore intended that such variations be included within the scope of the following claims and their equivalents.

I claim:

1. An apparatus comprising:
a wireless locator, wherein said wireless locator receives signals and, from those signals, determines its position, and wherein said position is defined by positional coordinates;
a mapper, wherein said mapper maps at least a first perimeter based on said position of said wireless locator;
a calculator, wherein said calculator determines a vector of movement of said wireless locator; and
a stimulator, wherein said stimulator generates a stimulus based, at least in part, on a relative likelihood of said wireless locator crossing said first perimeter, wherein said likelihood comprises a function of said vector of movement and said position of said wireless locator.

2. The apparatus of claim 1 wherein said wireless locator receives signals from orbiting transmitters.

3. The apparatus of claim 1 wherein said wireless locator receives signals from terrestrial transmitters.

4. The apparatus of claim 1 wherein mapper maps said first perimeter using a single set of said positional coordinates from said wireless locator.

5. The apparatus of claim 1 wherein said mapper maps a first perimeter having an arbitrary shape using a plurality of sets of said positional coordinates from said wireless locator.

6. The apparatus of claim 1 wherein said mapper maps an outer perimeter for containment and an inner perimeter for exclusion.

7. The apparatus of claim 1 wherein said mapper maps a second perimeter when said satellite positioning system is beyond said first perimeter.

8. The apparatus of claim 1 wherein said stimulus is a sound.

9. The apparatus of claim 1 wherein said stimulus is an electric shock.

10. The apparatus of claim 1 wherein said stimulus further comprises an electric shock.

11. The apparatus of claim 1 wherein a severity of said stimulus is a function of said likelihood of crossing said first perimeter.

12. The apparatus of claim 1 wherein:
said wireless locator is within said first perimeter; and
a direction of said vector of movement is toward said first perimeter; then
a severity of said stimulus increases as a magnitude of said vector of movement increases.

13. The apparatus of claim 10 wherein at a relatively lower likelihood of crossing said first perimeter, said stimulus is said sound, and at a relatively higher likelihood of crossing said first perimeter, said stimulus comprises said electric shock.

14. The apparatus of claim 1 wherein said stimulator stops generating said stimulus when said wireless locator crosses said first perimeter.

15. The apparatus of claim 1 wherein said stimulator does not generate a stimulus when said wireless locator is approaching said first perimeter from beyond said first perimeter.

16. The apparatus of claim 1 further comprising a fixed reference to improve accuracy of said wireless locator.

17. The apparatus of claim 1 further comprising a receiver, wherein said receiver receives a positional correction signal.

18. An apparatus comprising:
a receiver, wherein said receiver receives signals from a plurality of transmitters;
means for determining a position of said receiver from said received signals;
a calculator, wherein, based on said position, said calculator determines if said receiver is beyond a first perimeter; and
a mapper, wherein said mapper:
maps said first perimeter based on at least one set of positional coordinates determined by said means; and
maps a second perimeter when said receiver is determined to be beyond said first perimeter.

19. The apparatus of claim 18 wherein said calculator calculates a vector of movement of said receiver.

20. The apparatus of claim 19 wherein said receiver is at a position within said first perimeter, said apparatus further comprising a stimulator, wherein said stimulator generates a stimulus as a function of said vector of movement and said position.

21. The apparatus of claim 20 wherein said stimulator stops generating said stimulus when said receiver crosses said first perimeter heading toward said second perimeter.

22. An apparatus comprising:
a wireless locator, wherein said wireless locator is capable of determining its position;
a mapper, wherein said mapper maps a first perimeter based on at least one position of said wireless locator; and
a stimulator, wherein:
said stimulator generates a stimulus when said wireless locator is within a first distance of said first perimeter and is heading toward said first perimeter from a first side of said first perimeter; and
said stimulator does not generate a stimulus when said wireless locator is within said first distance of said first perimeter and is heading toward said first perimeter from a second side of said first perimeter.

23. The apparatus of claim 1 wherein said first side is within said first perimeter and said second side is outside of said first perimeter.

24. The apparatus of claim 1 wherein said first side is outside of said first perimeter and said second side is within said first perimeter.

25. An apparatus comprising:
a wireless locator, wherein said wireless locator is capable of determining its position;
a mapper, wherein said mapper maps a first perimeter based on at least one position of said wireless locator; and
a stimulator, wherein:
said stimulator generates a stimulus when said wireless locator is within a stimulation zone;
a distance between a beginning of said stimulation zone and said first perimeter is variable in distance; and
said distance is determined as a function of a vector of movement and position of said RF receiver.

26. A method comprising:
establishing a first perimeter based on positional coordinates of a wireless locator;
calculating a vector of movement and a position of said wireless locator relative to said first perimeter; and
generating a stimulus based on said vector of movement and said position of said wireless locator relative to said first perimeter.

27. The method of claim 26 further comprising establishing a second perimeter if said wireless locator is outside of said first perimeter.

28. The method of claim 26 further comprising not generating a stimulus when said wireless locator approaches said first perimeter from outside of said first perimeter.

29. The method of claim 26 further comprising varying a severity of said stimulus as a function of a likelihood of crossing said first perimeter from inside of said first perimeter.
